(19) United States
(12) Patent Application Publication
(10) Pub. No.: US 2020/0013099 A1
(43) Pub. Date: Jan. 9, 2020

(54) System for Tagging and Tracking Ammunition

(71) Applicant: Kenneth Wayne Jarvis, Santa Cruz, CA (US)

(72) Inventor: Kenneth Wayne Jarvis, Santa Cruz, CA (US)

(21) Appl. No.: 16/555,862

(22) Filed: Aug. 29, 2019

Related U.S. Application Data
(63) Continuation of application No. 15/340,665, filed on Nov. 1, 2016.
(60) Provisional application No. 62/289,185, filed on Jan. 29, 2016.

(51) Int. Cl. G06Q 30/06; G06Q 40/08; G06Q 20/20; F42B 35/00

(52) U.S. Cl. CPC G06Q 30/0607; F42B 35/00; G06Q 20/20; G06Q 40/08

(57) ABSTRACT

A method involves inscribing a unique ballistic information number (BIN) on a bullet in process of manufacture of a cartridge, the cartridge including a shell casing holding the bullet, recording the BIN in a network-connected database, recording, at point of sale, identity of a person who purchases the cartridges, associating the person who purchases the cartridges in the network-connected database with the BIN inscribed on the bullet and recorded in the network-connected database, and transacting an insurance policy insuring the person for liability for damages caused by use of the cartridges and associating the insurance policy with the identity of the person in the network-connected database and with the BIN.

### CROSS-REFERENCE TO RELATED DOCUMENTS

The present application is a continuation application of co-pending application Ser. No. 15/340,665, filed Nov. 1, 2016, which claims priority to provisional application 62/289,185, filed Jan. 29, 2016. All disclosure of the parent application is incorporated herein at least by reference.

### BACKGROUND OF THE INVENTION

### 1. Field of the Invention

The present invention is in the field of ballistic identification and pertains particularly to methods and apparatus for identifying a bullet in any one of a variety of circumstances.

### 2. Discussion of the State of the Art

The art of ballistic forensics is the art of matching a fired bullet to a gun or rifle from which the bullet was fired. In general, rifle and other gun barrels are rifled on the inside to produce spin for a bullet passing through the barrel, the spin aiding in providing a straight flight path of the bullet once it leaves the barrel. When bullets are recovered from such as a crime scene they may be saved as evidence, and if a suspicious weapon is recovered later, that weapon may be used in a firing chamber to produce a freshly-fired bullet for comparison to one or more bullets found at the scene.

The rifling on every barrel is unique to that barrel, like a fingerprint. Therefore, each bullet fired from the gun or rifle barrel will have essentially identical rifling marks, which are a negative impression of the rifling carved into the bullet in the form of lands and grooves, forming a negative impression of the barrel rifling.

One challenge with this technique of ballistic identification is that over time the rifling in the gun barrel becomes worn and changes physically due to repeated firing, the forces acting within the barrel, and in some cases erosion. While a first bullet fired may have a clear and crisp impression of the rifling, the impression will erode and change somewhat on later-fired bullets. Erosion of the gun rifling depends in part on the frequency of use (heavy, light) and condition of the weapon, including the state of the rifling inside the barrel. This can be a forensic drawback for investigators trying to tie a crime to a weapon and a suspect.

More recently forensic investigators have access to much better analysis tools, including spectrum analysis tools and superior magnification tools. While these tools help to mitigate questionable bullet and gun comparisons, there is no means to tie a bullet to a gun that has not been recovered. Therefore, ballistics identification remains largely an ad-hoc method that may provide results only when both the bullet(s) and the suspected gun are recovered and can be tested.

Some manufactures now include mechanisms for imprinting the make, model, and serial number of the gun onto a cartridge housing the bullet at the time it is fired. However, these micro-stamps, as they are sometimes referred to, are subject to extreme wear, and may eventually disappear from the mechanism used to imprint the stamp onto the cartridge.

When a gun is fired, the chamber and associated parts are subjected to immense pressure and friction. Along with the rifling, all physical mechanical components, such as the firing pin, etc. are in a constant process of erosion and decay. Micro-imprint characters on a firing pin are no different. Micro-imprint characters transferred to a bullet casing or cartridge by a firing pin, for example, may become chipped, cracked, or worn. The space between the pin surface and top surface of the micro-characters may also become filled with softer metal, resulting from stuck primers rendering the imprint partially or wholly non-discernable. Cartridges may be ejected when a gun is fired and they may also be recovered at the crime scenes. However, it is also common practice for criminals to collect all of the cartridges from a scene of a shooting after they have fired a weapon. Furthermore, some weapons auto-collect all of the cartridges within the firearm rather than rejecting the cartridges.

Therefore, what is clearly needed is a method and apparatus for imprinting a unique identification number on a bullet that may be cross referenced to a gun owner who purchased the ammunition, and that avoids wear problems associated with the weapon and its parts.

### BRIEF SUMMARY OF THE INVENTION

In one embodiment of the invention a method is provided, comprising inscribing a unique ballistic information number (BIN) on a bullet in process of manufacture of a cartridge, the cartridge including a shell casing holding the bullet, recording the BIN in a network-connected database, recording, at point of sale, identity of a person who purchases the cartridges, associating the person who purchases the cartridges in the network-connected database with the BIN inscribed on the bullet and recorded in the network-connected database, and transacting an insurance policy insuring the person for liability for damages caused by use of the cartridges and associating the insurance policy with the identity of the person in the network-connected database and with the BIN.

In one embodiment the method further comprises associating new BINs of cartridges subsequently purchased by the person with the identity of the person and the liability insurance policy in the network-connected database. In another embodiment a plurality of cartridges have bullets each inscribed with a common BIN, the plurality is securely packaged together with the common BIN inscribed on the package, and sold to the person, and the identity of the person is associated in the network-connected database with the number of bullets in the package and the common BIN. In one embodiment the BIN is inscribed on the bullets on a boat-tail of the bullets where impact damage and rifling marking may be least evident after firing the bullet from a cartridge. And in one embodiment the method further comprises transacting insurance policies for cartridge manufacturers, distribution enterprises and retail outlets for damage caused by use of the cartridges, inscribing all bullets manufactured with BINs, and updating the network-connected database as cartridges are sold and transferred for every step in ownership transfer, down to individual persons or institutions. In another embodiment the method further comprises enabling specific persons and institutions access to the network-connected database to discover owners and assign liability for damage found to be caused by cartridges to persons or property.

In another aspect of the invention a system is provided, comprising a network-connected database, a plurality of cartridges, including shell casings and bullets, the bullets inscribed with a unique ballistic information number (BIN) in process of manufacture of the cartridges, and a point-of-sale merchant engaged in selling the cartridges. Identity of a person purchasing the cartridges at the point-of-sale merchant is recorded in the network-connected database associated with the BIN, and an insurance policy insuring the person for liability for damages caused by use of the cartridges is transacted and recorded in the network-connected database at time of sale.

In one embodiment the system further comprises associating new BINs of cartridges subsequently purchased by the person with the identity of the person and the liability insurance policy in the network-connected database. In one embodiment a plurality of cartridges have bullets each inscribed with a common BIN, the plurality is securely packaged together with the common BIN inscribed on the package, and sold to the person, and the identity of the person is associated in the network-connected database with the number of bullets in the package and the common BIN. In one embodiment the BIN is inscribed on the bullets on a boat-tail of the bullets where impact damage and rifling marking may be least evident after firing the bullet from a cartridge. In one embodiment the system further comprises transacting insurance policies for cartridge manufacturers, distribution enterprises and retail outlets for damage caused by use of the cartridges, inscribing all bullets manufactured with BINs, and updating the network-connected database as cartridges are sold and transferred for every step in ownership transfer, down to individual persons or institutions. And in one embodiment the system further comprises enabling specific persons and institutions access to the network-connected database to discover owners and assign liability for damage found to be caused by cartridges to persons or property.

### BRIEF DESCRIPTION OF THE SEVERAL VIEWS OF THE DRAWINGS

FIG. 1 is an elevation view of a bullet fired by a weapon in current art.

FIG. 2A is a cross-sectional view of a rifle barrel showing rifling of the barrel in current art.

FIG. 2B is a cross-sectional slice of the bullet of FIG. 1 depicting rifling marks carved therein by the barrel of the weapon of FIG. 1 in current art.

FIG. 3 is an end view of a cartridge depicting a micro-stamp imprint stamped onto the primer of a cartridge according to current art.

FIG. 4 is an end view of a bullet with a unique laser-printed ballistic identification number printed thereon according to an embodiment of the present invention.

FIG. 5A is a cross-sectional view of an unspent hand gun cartridge according to current art.

FIG. 5B is a side elevation view of the bullet of FIG. 5A according to current art.

FIG. 5C is an end view of the bullet of FIG. 5B with a laser printed ballistic identification number.

FIG. 6A is a cross-sectional view of a rifle cartridge having a bullet imprinted with a ballistic identification number according to an embodiment of the present invention.

FIG. 6B is a front elevation view of the bullet of FIG. 6A depicting the ballistic identification number of FIG. 6A.

FIG. 7 is a front elevation view of a box of ammunition depicting a ballistic identification number on a bar code surface according to an embodiment of the invention.

FIG. 8 is an architectural overview of a communications network that supports ballistic identification and matching according to an embodiment of the invention.

FIG. 9 is a flow chart depicting steps for validation of an ammo purchase by a gun owner in lieu of insurance using a ballistic identification number according to an embodiment of the invention.

FIG. 10 is a process flow chart depicting steps for retrieving one or more bullets from a crime scene and matching the bullet or bullets recovered to a gun owner through a ballistic identification number according to an embodiment of the invention.

### DETAILED DESCRIPTION OF THE INVENTION

In various embodiments described in enabling detail herein, the inventor provides a unique ballistic identification method and system for matching fired bullets to gun owners. The present invention is described in enabling detail using the following examples, which may describe more than one relevant embodiment falling within the scope of the present invention.

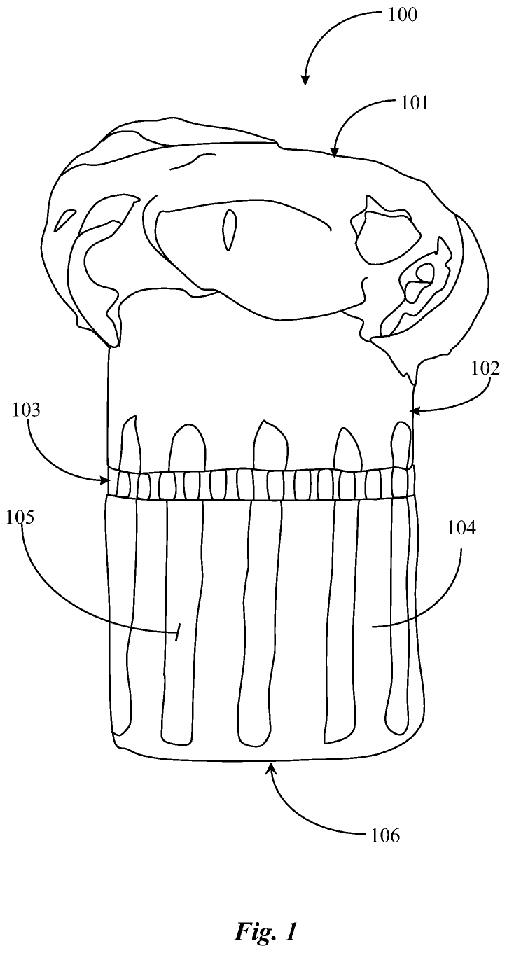

FIG. 1 is an elevation view of a bullet 100 fired by a weapon in current art. Bullet 100 includes a mushroomed head as a result of the bullet having struck an object or a person. The area where a bullet becomes severely deformed is typically the point of the bullet, and this area will not support a printed or stamped ballistic identification number (BIN). Bullet 100 includes a bearing surface 102, which makes contact with the inside surface of the barrel of the weapon that fired it, as it passes through the barrel.

In this depiction of a current art bullet, a cannelure 103 is provided to extend radially around the outside surface of the bullet. Cannelure 103 is a groove around the bullet into which a cartridge case is crimped, so the bullet is held firmly in the bullet casing or cartridge until the maximum amount of pressure has built up within the cartridge at firing. In this depiction, lands 104 and grooves 105 are imprinted on the bullet by the rifling of the gun barrel producing a negative image of the barrel rifling as described further above. Surface 106 is the bottom surface of the bullet. Surface 106 maybe the most desired surface on which to imprint a BIN, as this surface is not affected by the gun barrel or by hitting an object in flight.

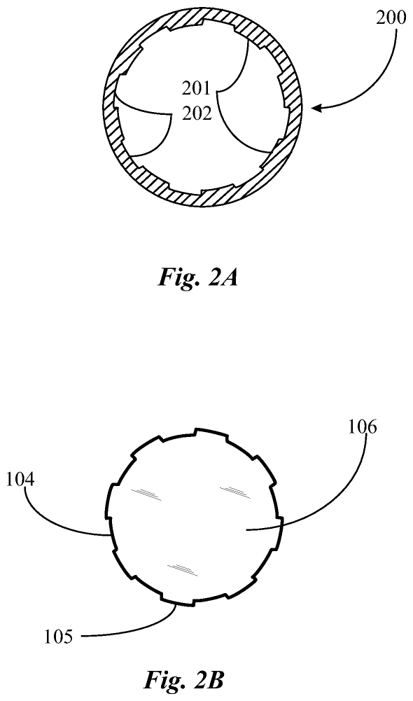

FIG. 2A is an exemplary cross-sectional view of a rifle barrel 200 showing rifling of the barrel in current art. Rifling of barrel 200 is represented by lands 201 and grooves 202. These lands and grooves spiral down the barrel and interact with the bullet to produce spin for the bullet as the bullet travels the length of the barrel.

FIG. 2B is a cross-sectional slice of the bullet of FIG. 1 depicting rifling marks carved therein by the rifling grooves of barrel 200 in current art. Bottom surface 106 represents a flat surface on the bullet that may not be affected by erosion and friction damage that may occur to other surfaces of the bullet during firing and upon impact. Lands 104 and grooves 105 represent the imprints left on the bullet after it is fired through a rifled barrel. Surface 106 maybe the most desired surface to imprint on as it is not affected by the gun barrel or by hitting an object in flight.

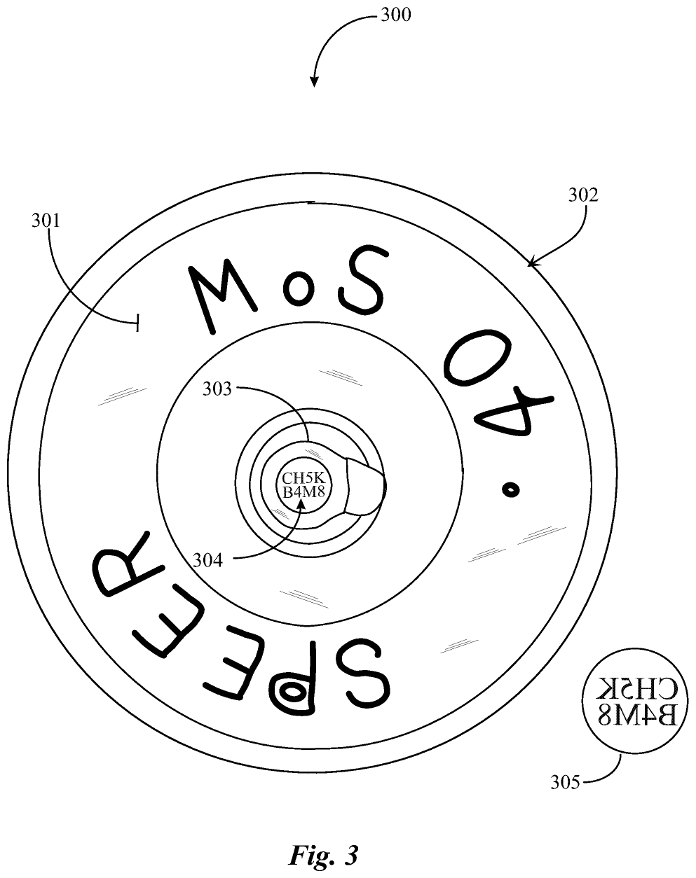

FIG. 3 is an end view of a cartridge 300, depicting a micro-stamp imprint 304 stamped onto the primer 303 of the cartridge according to current art. Cartridge 300 includes a bullet jacket 302, and a cartridge base surface 301. In this depiction, micro-stamp 304 is stamped onto cartridge primer 303 by the firing pin 305 of the weapon. The micro-stamp typically may reflect the make and or model number, or perhaps serial number of the weapon. In an associated exploded view, firing pin 305 is shown illustrating the micro-stamp in mirror image. In these examples the character strings of micro stamps are not intended to be unique for each cartridge.

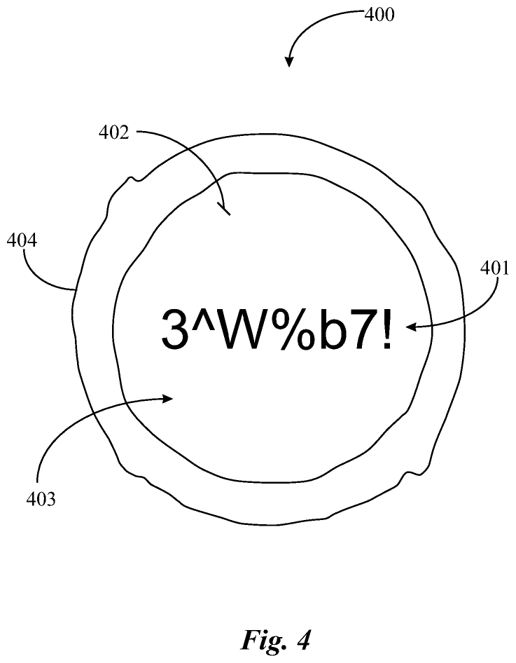

FIG. 4 is an end view of a bullet 400 with a unique laser-printed ballistic identification number printed thereon according to an embodiment of the present invention. Bullet 400 has a BIN 401 physically implemented on a bottom surface 403 of a lead core. In this case the physical method is laser printing through a laser mask 402. Laser mask 402 covers bottom surface 403 of bullet 400 and extends to cover a bullet jacket 404.

Laser mask 402 is used to protect bullet 400 from any unwanted marks or scratches while undergoing laser printing. An example bullet 400 receiving unique BIN 401 might be a .45 caliber full metal jacket bullet. The process may be applied to many other bullet types without departing from the spirit and scope of the invention. The laser may be a C02 laser that engraves BIN 401 on a single bullet with a different character string used for a subsequent bullet and so on for every bullet manufactured. In one embodiment, BIN 401 may be printed on a set of bullets, such as a set of 50 .45 caliber bullets packaged in an ammunition box. The laser may provide an imprint deep enough into the lead core to withstand the momentary heat, pressure, and violence of detonation, and the forces of rapid deceleration on impact.

BIN 401, in this example, is associated to a person that purchased ammunition bearing the unique BIN or BINs assuming single bullet application rather than a set of bullets sharing one BIN. The way the owner of the ammunition is associated to the BIN is through a databank that may store all of the generated BIN numbers. More about the association of a gun owner to ammunition bearing a BIN such as BIN 401 is described further below in this specification. The BIN may comprise ASCII characters in a string of characters. There are 95 printable ASCI characters if the space character is included. Other character types or genres may also be used in place of ASCII characters without departing from the spirit and scope of the present invention. Each unique BIN applied by a manufacturer may be stored and recorded for later matching when a person purchases that ammunition bearing the BIN. BINs may be, in one implementation, randomly generated as long as no two BINs or BIN sets are exactly alike.

BIN 401 has a character string that uniquely identifies bullet 400. In the manufacturing process one BIN may be used on a number of bullets, such as 50 bullets, which, having the same BIN, may be placed in a single box of ammunition. A BIN might be placed on other surfaces of a bullet provided that surface could withstand the forces of being fired through the barrel, including the forces of detonation, creation of lands and grooves (rifling imprints), and deformation at impact. After the BIN is applied, the bullet is mated with a cartridge, rendering the BIN inaccessible and therefor unalterable, as it is sealed within the cartridge.

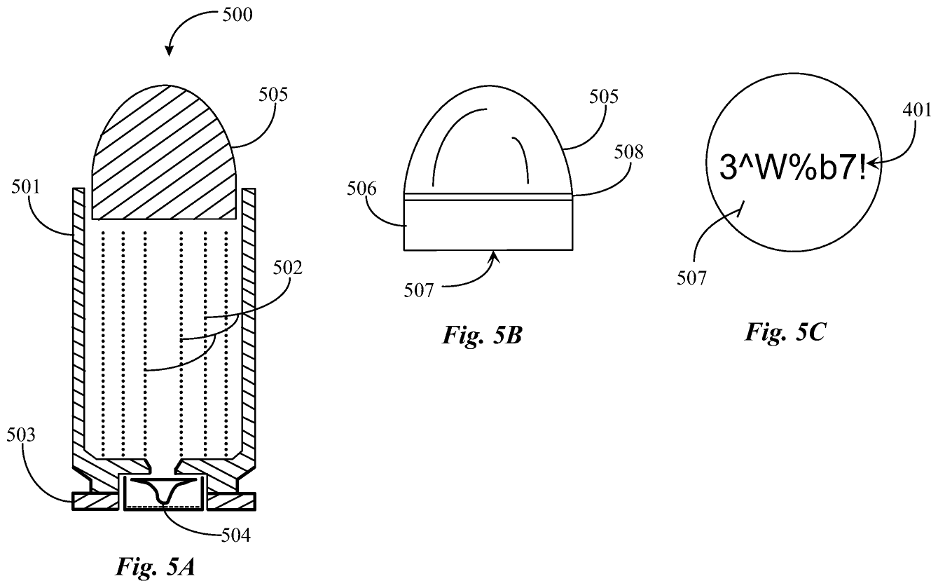

FIG. 5A is a cross-sectional view of a cartridge 500 according to current art. FIG. 5B is a side elevation view of bullet 505 of FIG. 5A according to current art. FIG. 5C is a rear end view of bullet 505 of FIG. 5B with a ballistic identification number according to an embodiment of the present invention. Referring now to FIG. 5A, a typical modern cartridge 500 is depicted in section view. Bullet 505 may be analogous to bullet 100 of FIG. 1. A metal jacket 501 encases bullet 505. Cartridge 500 is charged with powder or other propellant 502. Cartridge 501 includes a cartridge rim 503. A cartridge extractor of a weapon not illustrated extracts cartridges such as cartridge 501 by mechanically latching onto a cartridge rim, such as rim 503. A cartridge primer 504 is depicted as the strike point for a gun hammer (not illustrated).

Referring now to FIG. 5B, bullet 505 is depicted in elevation view (not sectioned), revealing a cannelure 508, which may be analogous to cannelure 103 of FIG. 1, and a bearing surface 506. Bearing surface 506 may be analogous to bearing surface 102 of FIG. 1. The bottom surface of bullet 507 may be a desired surface on this particular bullet to laser imprint or engrave a BIN, owing to the shape of bullet 505 and the fact that surface 507 does not make contact with the weapon barrel and is opposite the impact point on the bullet.

Referring now to FIG. 5C, the base end surface 507 of bullet 505 of FIG. 5B is marked with BIN 401 as described further above. BIN 401 may vary in variety and number of characters without departing from the spirit and scope of the present invention. The number of bullets manufactured in the United States ever year is currently above ten billion. Using the ASCI characters an example for character strings, by using a string of seven characters, as illustrated in FIG. 4, 94\hat{ }7=64,847,759,419,264 unique BINs may be instantiated.

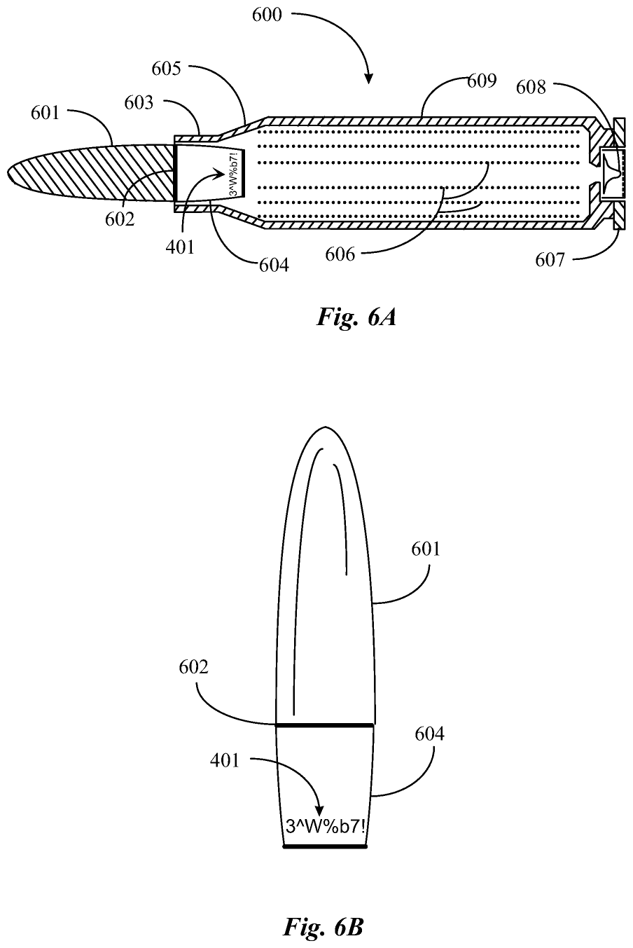

FIG. 6A is a cross-sectional view of a rifle cartridge 600 having a bullet imprinted with a BIN according to an embodiment of the present invention. FIG. 6B is an elevation view of bullet 601 of FIG. 6A depicting the BIN 401 of FIG. 6A. Cartridge 600 essentially includes the same elements previously described for cartridge 500 of FIG. 5A. A bullet 601 is depicted in partial section down roughly to a cannelure 602. In FIG. 6A bullet 601 is encased by a cartridge jacket 609. Cartridge Jacket 609 is elongate and includes a cartridge neck 603 and a cartridge shoulder 605. A cartridge rim 607 and cartridge primer 608 make up the firing end of rifle cartridge 600. Rifle cartridge 600 holds gunpowder or other propellant 606.

Unlike bullet 505 of FIGS. 5A, B and C, bullet 601 includes an aft section 604 referred to as a boat-tail in the art of ammunition manufacturing. Boat-tail 604 tapers from approximately the point of cannelure 602 to the firing end of bullet 601. Boat-tail 604 is adapted to provide more accuracy and stability in the flight of the bullet. Boat-tail 604 does not make contact with the barrel of the firing weapon. Likewise, boat-tail 604 is opposite and below the cannelure from the impact point of bullet 601 that would mushroom or shred. In this example, BIN 401 is laser engraved onto boat-tail 604 of bullet 601, in this case, orthogonally from the flight direction (longitudinal axis) of the bullet. Again, as described further above, rifle cartridge 609 seals BIN 401 inside the cartridge and beyond access for potential tampering.

Referring now to FIG. 6B, bullet 601 is depicted in elevation view removed from the cartridge, depicting boat-tail 604, BIN 401, and Cannelure 602. In one embodiment, BIN 401 may be engraved in line, that is linearly in the flight direction of the bullet, rather than around the circumference as shown in FIG. 6B. Engraving the BIN about the circumference of boat-tail 604 provides sufficient protection against the marks from rifling that would occur above cannelure 602, well opposite of the impact point of bullet 601 subject to mushroom or shear on impact. In one embodiment, BIN 401 may also or instead be placed across the base surface of the bullet.

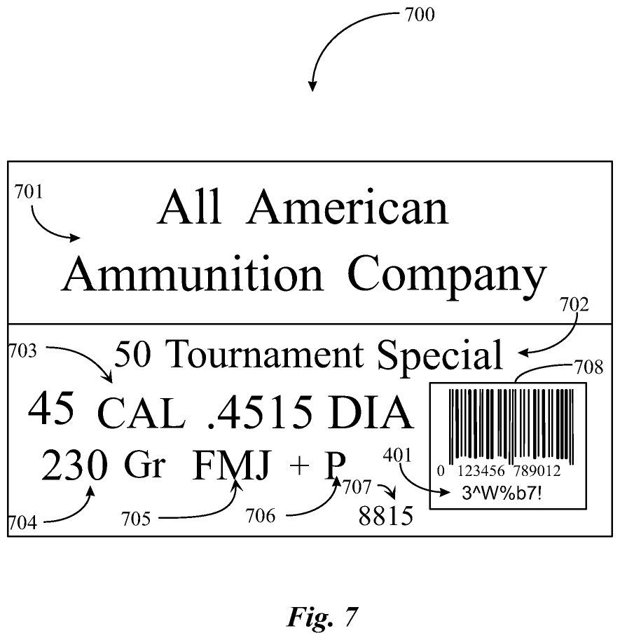

FIG. 7 is a front elevation view of a box of ammunition 700 depicting a ballistic identification number 401 on a bar code surface according to an embodiment of the invention. In one embodiment bullets belonging to a set of like bullets may all receive one BIN to uniquely identify that specific batch of more than one manufactured bullet.

Ammunition box 700 has a company logo 701, a cartridge label 702 that includes indication of the number of cartridges packed into in box 700. Box 700 also includes printed information specifying the cartridges including gauge of .45 caliber (element 703), Grain (Gr) 230 (element 704), and specification of full metal jacket (FMJ) (element 705) with a higher than standard charge (+P) (element 706). A lot or batch number 8815 (element 707) printed lower right on box 700 specifies the Mfg. record of the group of bullets packaged.

It is typical that a bar code 708 is provided on box 700. In this example, BIN 401 accompanies bar code 708 and may be optically scanned. BIN 401 may be uploaded into a centralized databank on a communications network and, perhaps locally for storage and later association with a purchaser of the ammunition. In one embodiment a person is tied to a BIN of purchased ammunition such as box 700 through a liability insurance service taken out for purchased ammunition. The liability insurance system is described below in enabling detail.

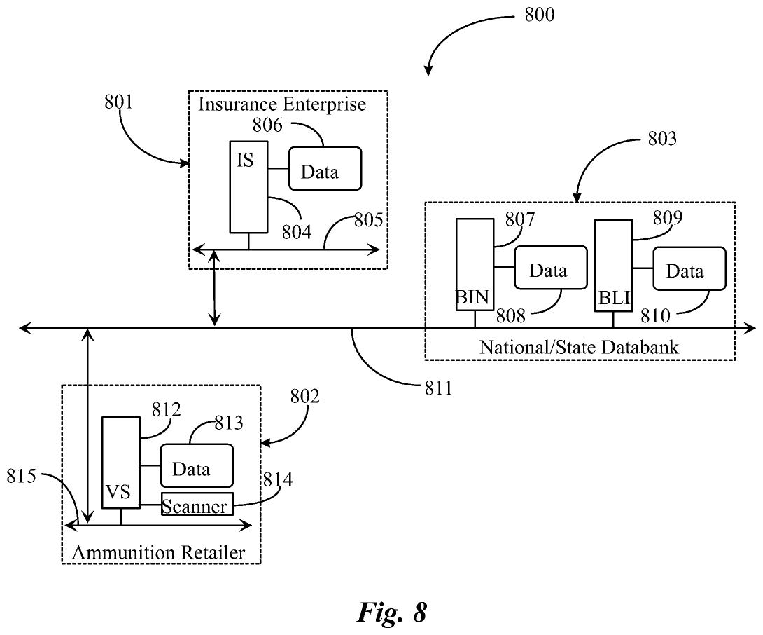

FIG. 8 is an architectural overview of a tracking and liability system interacting over a communications network 800, that supports ballistic identification and matching according to an embodiment of the invention. Network 800 in this example includes the well-known Internet network illustrated by a network backbone 811. Internet backbone 811 includes all of the lines, equipment, and access points that make up the Internet as a whole including any connected sub-networks.

An ammunition retailer 802 in this system has a network access connection to Internet 811 via a local area network (LAN) 815. Ammunition retailer 802 includes a verification server (VS) 812 adapted to verify an insurance certificate or like proof of ammunition liability insurance for any person who may be attempting to purchasing ammunition. Such a certificate or other proof may be scanned into server 812 using a scanner 814 having connection to VS 812. VS 812 has connection to a data repository 813 that stores data, such as customer data, manufacturing data, customer account data, local BIN records, and any other data deemed important for storage and later retrieval or archive.

In one embodiment of the invention an insurance enterprise may offer ballistic liability insurance (BLI) for individuals. The insurer may be a public or a private facility, but may in many instances be the same insurance enterprises that provide such as homeowner's insurance, automobile insurance, property insurance and the like. Such an insurer is indicated by insurance entity 801. In one embodiment the insurer may specialize in ammunition insurance. In this example architecture, insurer 801 includes a local area network (LAN) 805 that has access to Internet 811 via network access line and service. LAN 805 supports an insurance server (IS) 804. Insurance server 804 may be adapted to underwrite and calculate pricing of a BLI product of which there might be more than one product available. IS 804 has connection to a data repository 806 which may be adapted to hold customer information, account information, insurance information, pricing, and insured status information for insurance policies taken out by customers covering ammunition purchased by the customer.

In this example it is presumed that a person intending to purchase ammunition for any firearm will purchase an insurance policy to cover the ammunition to be purchased. When a person takes out a policy with insurer 801, the insurer collects information from the applicant such as personal identity, address, phone number, employment information, social security number, and known felony record or pending legal actions, and so on. The insurer may conduct a background check on the applicant to determine whether the applicant should be insured based on history including mental health, criminal history, civil history (restraining orders, and so on).

In order to purchase ammunition from a retailer such as retailer 802, a potential purchaser must be insured for the liability of owning ammunition, and damage that might ensue to others and property that might later be linked to that ammunition. Databank 803 might be a centrally located federal databank or one of state-run databanks that may be cross-linked to one another.

IS 804 may upload information of a new insurance policy taken out by a potential purchaser of ammunition to a BLI server 809 within the domain of databank 803. The uploaded information may include the identity of the person, the residence address of the person, the work address of the person, the insurance policy number, the current status of the policy (active, not active, canceled, etc.). Insurer 801 may also issue an insurance certificate or card to a person that has been approved for insurance.

Further to the above, it is not just individual citizens who may purchase ammunition that must have ballistics liability insurance. Liability insurance in this system must follow the ammunition, that is, the individual bullets or packages of bullets, from manufacturer, to distribution channels, to retailers, and finally, to individual who purchase the ammunition, and to whom liability for use of the ammunition may be associated. So, every manufacturer must be insured for the bullets while they are still in possession and ownership of the manufacturer. As bullets change ownership, which may be through one or several different commercial entities, sale and transfer can only be made to entities that carry liability insurance, and liability moves with the purchase and transfer to the new owner.

Returning to the end purchaser, once an individual applicant has secured a policy and the policy is in effect, insurer 801, more particularly IS 804, may upload data identifying the policy, the new policy owner, and information pertaining to the policy owner to a central ballistic liability insurance server 809. Server 809 may store the data in a connected data repository such as data repository 810. An insured person may purchase ammunition at gun dealer 802. The person may present a certificate of insurance issued by insurer 801 to ammunition retailer 802 in order to qualify to buy ammunition. For example, scanner 814 may be used to scan in the insurance information to a validation server (VS) 812. Validation server 812 may, by virtue of Internet connection, access BLI server 809 and validate the insurance card and information associated with the card before authorizing the person to buy ammunition. If the information checks out, the ammunition may be sold to the person. It may be noted herein that a potential purchaser may, in one embodiment, purchase ammunition and apply for insurance in one stop at the ammunition retailer 802. However, ammunition may not be delivered to or otherwise be made available to the person until the person has passed associated background checks.

If validation server 812 returns approval for ammunition purchase, the server may read the BIN(s) on the ammunition package and store the data in a connected data repository 813. Further, VS 812, by virtue of Internet connection, may upload the BIN(s) to databank 803, more particular to a BIN server 807, to be added to the centralized information. BIN server 807 may store the information in a data repository 808. BIN server 807 may also access data in repository 810 and may look up the insurance data for a purchaser and append the data by adding the ammunition information to the insurance information for the owner. In this way a cross-referenced record is created that identifies the ammunition sold and the purchaser of the ammunition. Likewise, an additional data record may be kept at databank 803. For example, if an insured person has lost or believes that ammunition identified by covered BIN has been stolen, the person may report this information to insurer 801 and or to retailer 802. The data for the person may be appended with the information that particular ammunition was reported stolen and status may be updated.

One purpose for associating the ammunition with the person through insurance is to enable officials investigating a crime scene, for example, to retrieve BINs of bullets recovered from a shooting and to verify in the field who originally purchased that ammunition. In the case of stolen ammunition, weapons of the owner, which weapons may be separately registered, may be recovered and eliminated as the firing weapon, thus clearing the person. As described briefly above, manufacturers, distribution resellers, and ammunition retailers are to carry ballistics liability insurance, and will be vetted for insurance, and insured by insurance enterprises. Costs, payment and the like is determined as private practice between corporate entities and the insurers. In the system, the original manufacturer of bullets marks the bullets with BIN numbers, notifies the insurer of new bullets in the system, and is liable for the new bullets until sold and transferred to a different entity. When and as a shipment of ammunition is sold and shipped to, for example, a distributor, the fact of the sale and change of liability is communicated to at least the databank 803. This process is followed, tracking ownership (and liability) through to final purchase by an individual citizen, or in many embodiment to, for example, agencies of law enforcement, who, in some embodiments, may also be subject to liability insurance and record keeping.

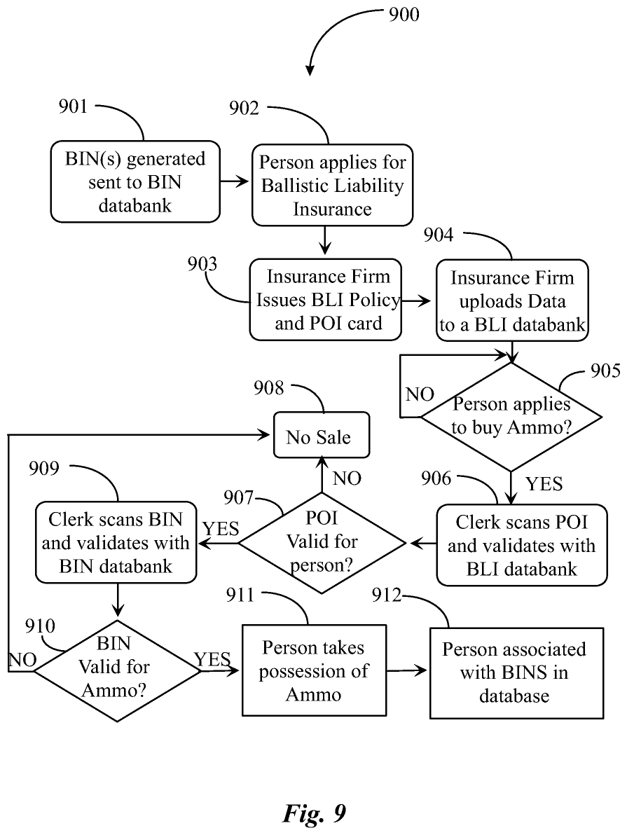

FIG. 9 is a flow chart 900 depicting steps for validation of an ammo purchase by an individual, according to an embodiment of the invention. At step 901, it is presumed that ammunition on the shelf at an ammunition retailer has BIN(s) imprinted on the ammunition, with the numbers stored locally, and perhaps in a remote database as well. At step 902, not depending on step 901, a person gets ballistic liability insurance to cover purchases of ammunition. At step 903, the insurer may issue a ballistic liability policy (BLI) to the person, clearing the way for purchase of ammunition from a retailer. In this step the insurer may also issue a proof of insurance (POI) card or certificate.

At step 904, data given to the insurer by the gun owner is uploaded along with proof of insurance (POI) to the databank analogous to databank 803 of FIG. 8. In this step the insurer may also present the owner with a POI card or certificate. The BLI data may include owner ID and address, workplace address, contact data, etc. The insurance data may define the policy purchased, ammunition specifications, limits of liability, and so on.

At step 905, it may be determined whether or not the person has purchased any ammunition. If the owner has not attempted to buy ammunition at step 905, then the process may loop until a purchase has been identified. If at step 905 a person is attempting or is in the process of purchasing ammunition, the process may move to step 906. At step 906, the person may present a POI card to the retailer to be scanned in or otherwise recorded for verification. Also in this step the retailer may attempt to validate the POI certificate or card with the national or state BLI databank. At step 907, the retailer determines whether the POI presented is valid or not. If at step 907, the BLI databank does not confirm the POI card or certificate is active and that of the owner, the process may move to step 908 where no sale is made.

If it is determined at step 907 that the presented POI is valid and belongs to the person attempting to purchase the ammunition, the sale proceeds and the BIN or BINs associated with the ammunition sold are scanned and validated against BINs previously generated by the manufacturer for that ammunition. In one embodiment the BIN or BINs are uploaded when the ammunition is sold along with ID of the person and insurance data to the national or state databank. In a preferred embodiment the manufacturer generates the BINs and the retailer scans and then validates that the scanned BIN or BINs are in the databank and are correct. For example, BINs imprinted on the lead core of the bullet are not accessible to the retailer without destroying the ammunition. Therefore, the BIN or BINs are reported to the retailer for ammunition that has been delivered or distributed to the retailer for sale. In one embodiment a BIN engraved onto a bullet may also be put on the cartridge jacket in manufacturing only to validate that the bullet BIN is the same number for that round. In this way, if ammunition containing a BIN gets mixed with ammunition of another BIN, it may be sorted out visually and without pulling the bullet from the jacket.

At step 910, the retailer may check whether the BIN or BINs on an unopened box of ammunition are valid for the ammunition, that is to say that the BIN or BINs scanned from the box were listed in the BIN databank by the manufacturer. If at step 910, if the number(s) on the box do not match or are not entered into the databank the process may move to step 908 where there is no sale for that ammunition. In such a case it may be that the box has the wrong number(s) or somehow ammunition got into a wrong box. A visual inspection of the ammo inside the box may reveal the BIN(s) if they were also printed somewhere on the jacket covering the bullet. If at step 910, the BIN(s) are valid for the ammunition, the process may move to step 911 where the sale is concluded and the owner takes possession of the ammunition. If ammunition is marked with a unique BIN individually, a box of 25 cartridges may have 25 separate but sequentially applied BINs. At step 912 the fact of transfer to the person is communicated to the databank, and the person is now associated with the ammunition purchased by the BIN numbers, and is henceforth liable for that ammunition.

If batches of ammunition receive a single BIN, then only one BIN may be added to information on the outside of the box, that may be scanned. Any ammunition purchased triggers BIN validation and all of the BINs are associated to the purchaser and hence to the BLI policy of the purchaser. In one embodiment the present invention may also be applied to professional services like police, security guards, and the military. In this way, rounds recovered in any field investigation, be it civilian or military, will have traceable BINs that can be associated with original purchasers or providers of that ammunition.

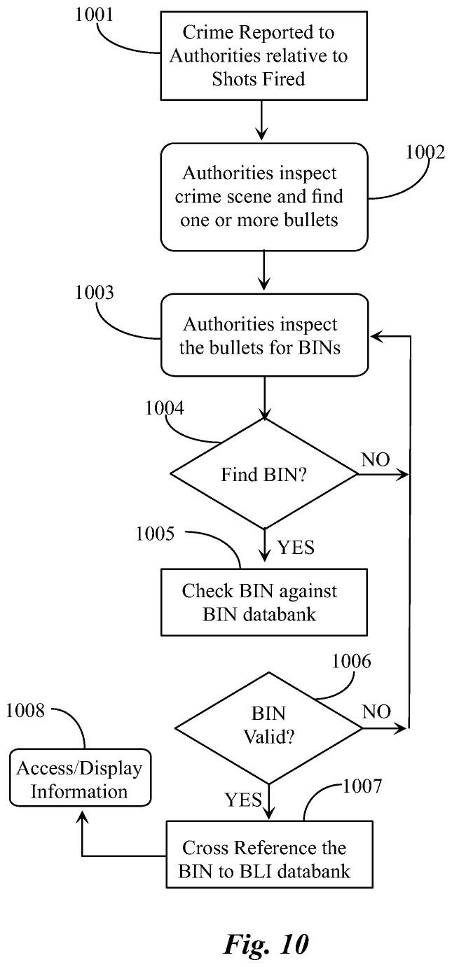

FIG. 10 is a process flow chart 1000 depicting steps for retrieving one or more bullets from a crime scene and matching the bullet or bullets recovered to a gun owner through a ballistic identification number according to an embodiment of the invention. At step 1001, a crime involving a shooting or shot fired may be reported to authorities such as police. At step 1002, responding authorities may recover one or more bullets from the crime scene. Recovered bullets may also include those lodged in persons and recovered at surgery.

At step 1003, the authorities may inspect the one or more bullets for evidence of a BIN. At step 1004, the authorities may determine whether or not a BIN has been found. If no BIN has been found at step 1004, the process may move back to step 1003. If one or more BINs are found on the bullets, the BIN or BINs are checked against the BIN databank at step 1007 to determine the owner of the ammunition and the status of the policy covering the ammunition (stolen, policy active, etc.). The information may be returned to the authorized accessing device and displayed at step 1008. The information may be checked from the crime scene or later from a lab or hospital, or from anywhere a bullet may be recovered.

Because only a very small number of the ten billion bullets produced in America every year may end up at a crime scene, BLI premiums may be based on risk, not on the number of bullets in possession. If an individual possesses the minimum BLI policy, it might be a blanket policy for as many rounds as an individual may wish to possess. Ballistic Liability Insurance rates may be based on risk the same way motor vehicle rates are based. An individual that is an indoor competitive marksman and is a member of a shooting club and never hunts might pay a lesser rate than a deer hunter who shoots in the woods. An individual that has a checkered past with law enforcement, or civil problem with a neighbor, etc. may be denied insurance and thus not be able to buy ammunition. Others who may have had some problems but are not currently seen as a danger may still be able to get insurance but the premiums might be higher when underwritten than the previous two examples.

The BIN system may, in one embodiment, be an adjunct to the Integrated Automated Fingerprint Identification System (IAFIS), the national automated fingerprint identification and criminal history system maintained by the Federal Bureau of Investigation. The combination of a suspect's fingerprint found at a crime scene, and a BIN number that is linked to the same suspect may aid investigators in more efficient evidence gathering and in later arrest and prosecution of the suspect or suspects.

In one embodiment there may be a time period imposed for a BIN to live or to be considered active. For example, a box of ammunition with a BIN may become lost or otherwise destroyed at some point where the ammo was never used. In this case a long period, such as 10 years, might be sufficient to expire a BIN. In one embodiment, if ammunition is purposely destroyed such as by military or law enforcement, the action may be associated with the BINs such that those numbers may be cleared from the databank after that ammunition is destroyed.

In one embodiment ammunition with BINs may be transferred from one owner to another in a transaction where the new owner and his or her BLI policy is then associated with the BINs of the ammunition transferred. This might be accomplished at a participating retailer or at the insurance company that issued the BLI policy to the owner wishing to transfer the unused ammunition. It may be that only police-owned computing devices and devices operated by authorized ammunition dealers or the insurers issuing BLI policies may access the national or state databank.

As time passes, and availability and desirability of different materials and methods of manufacture change, there may be adjustments in certain aspects of the invention to accommodate new developments. An important aspect of the invention is that bullets be marked in some manner uniquely so they may be associated with a specific person who may acquire same, such as by purchase. As materials change, means of marking bullets may change as well, so if bullets are ceramic, for example, marking may still be done in some manner to apply the unique ID. In some cases markings may be other than by alphanumeric characters, such as by a type of bar code, which may be applied as visible markings, or may be incorporated on or in a bullet in a manner that may be read by a magnetic reader, for example. There are many possibilities.

It will be apparent to one with skill in the art that the ballistic identification and liability insurance system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention. The invention is limited only by the breadth of the claims below.

1. A method, comprising:
inscribing a unique ballistic information number (BIN) on a bullet in process of manufacture of a cartridge, the cartridge including a shell casing holding the bullet;
recording the BIN in a network-connected database;
recording, at point of sale, identity of a person who purchases the cartridges;
associating the person who purchases the cartridges in the network-connected database with the BIN inscribed on the bullet and recorded in the network-connected database; and
transacting an insurance policy insuring the person for liability for damages caused by use of the cartridges and associating the insurance policy with the identity of the person in the network-connected database and with the BIN.

2. The method of claim 1 further comprising associating new BINs of cartridges subsequently purchased by the person with the identity of the person and the liability insurance policy in the network-connected database.

3. The method of claim 1 wherein a plurality of cartridges have bullets each inscribed with a common BIN, the plurality is securely packaged together with the common BIN inscribed on the package, and sold to the person, and the identity of the person is associated in the network-connected database with the number of bullets in the package and the common BIN.

4. The method of claim 1 wherein the BIN is inscribed on the bullets on a boat-tail of the bullets where impact damage and rifling marking may be least evident after firing the bullet from a cartridge.

5. The method of claim 1 further comprising transacting insurance policies for cartridge manufacturers, distribution enterprises and retail outlets for damage caused by use of the cartridges, inscribing all bullets manufactured with BINs, and updating the network-connected database as cartridges are sold and transferred for every step in ownership transfer, down to individual persons or institutions.

6. The method of claim 1 further comprising enabling specific persons and institutions access to the network-connected database to discover owners and assign liability for damage found to be caused by cartridges to persons or property.

7. A system, comprising:
a network-connected database;
a plurality of cartridges, including shell casings and bullets, the bullets inscribed with a unique ballistic information number (BIN) in process of manufacture of the cartridges; and
a point-of-sale merchant engaged in selling the cartridges;
wherein, identity of a person purchasing the cartridges at the point-of-sale merchant is recorded in the network-connected database associated with the BIN, and an insurance policy insuring the person for liability for damages caused by use of the cartridges is transacted and recorded in the network-connected database at time of sale.

8. The system of claim 7 further comprising associating new BINs of cartridges subsequently purchased by the person with the identity of the person and the liability insurance policy in the network-connected database.

9. The method of claim 7 wherein a plurality of cartridges have bullets each inscribed with a common BIN, the plurality is securely packaged together with the common BIN inscribed on the package, and sold to the person, and the identity of the person is associated in the network-connected database with the number of bullets in the package and the common BIN.

10. The system of claim 7 wherein the BIN is inscribed on the bullets on a boat-tail of the bullets where impact damage and rifling marking may be least evident after firing the bullet from a cartridge.

11. The system of claim 7 further comprising transacting insurance policies for cartridge manufacturers, distribution enterprises and retail outlets for damage caused by use of the cartridges, inscribing all bullets manufactured with BINs, and updating the network-connected database as cartridges are sold and transferred for every step in ownership transfer, down to individual persons or institutions.

12. The system of claim 7 further comprising enabling specific persons and institutions access to the network-connected database to discover owners and assign liability for damage found to be caused by cartridges to persons or property.
